(19) United States
(12) Patent Application Publication
(10) Pub. No.: US 2019/0002643 A1
(43) Pub. Date: Jan. 3, 2019

(54) ENVIRONMENTALLY-SENSITIVE MATERIAL AND METHOD FOR MANUFACTURING SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/682,550

(22) Filed: Aug. 22, 2017

(30) Foreign Application Priority Data
Jun. 30, 2017 (TW) 106121875

(51) Int. Cl. C08G 81/02; C08F 283/00; C08F 290/06; C08F 120/06

(52) U.S. Cl. CPC C08G 81/025; C08F 283/006; C08G 2210/00; C08F 120/06; C08F 290/062

(57) ABSTRACT

An environmentally-sensitive material includes a sensitive layer and a base. The sensitive layer includes a mixed portion and a sensitive portion seamlessly connected to the mixed portion. The mixed portion is made of a mixture of a first polymer gel and a second polymer gel. The sensitive portion is made of the second polymer gel. The second polymer gel is a reversible gel which is able to revert to an original size and state as a changed environmental factor reverts to a starting state. A method for manufacturing the material is also provided.

### CROSS-REFERENCE TO RELATED APPLICATIONS

This application claims priority to Taiwanese Patent Application No. 106121875 filed on Jun. 30, 2017, the contents of which are incorporated by reference herein.

### FIELD

The subject matter herein generally relates to environmentally-sensitive material and method for manufacturing same.

### BACKGROUND

Gel material is used in scientific research and biomedical science research and application. Environmentally triggered gel is one kind of gel material, and can be used in controlled release of drugs, microchannel control, bionic drive, and biological separation.

### BRIEF DESCRIPTION OF THE DRAWINGS

Implementations of the present technology will now be described, by way of example only, with reference to the attached figures.

FIG. 1 is a cross-sectional view of an environmentally-sensitive material according to an exemplary embodiment.

FIG. 2 is a flow chart of an exemplary embodiment of a method for manufacturing an environmentally-sensitive material.

FIGS. 3 and 4 show a mold for manufacturing a sensitive layer of the material of FIG. 1.

FIG. 5 shows the sensitive layer on a transparent base board of the mold.

FIG. 6 shows a transparent frame positioned on the transparent base board and the sensitive layer of FIG. 3 received in the transparent frame.

FIG. 7 shows a base formed on a surface of the sensitive layer of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain sections have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

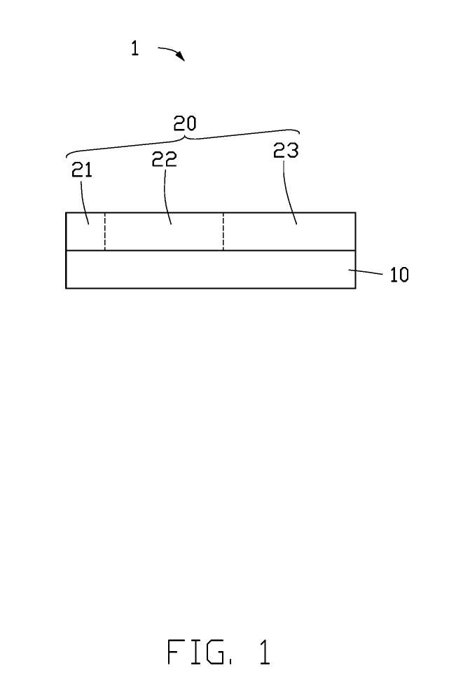

FIG. 1 illustrates an exemplary embodiment of an environmentally-sensitive material 1 including a sensitive layer 20 and a base 10 adhered with the sensitive layer 20.

The sensitive layer 20 includes a gel portion 21, a mixed portion 22, and a sensitive portion 23. The gel portion 21, the mixed portion 22, and the sensitive portion 23 are seamlessly and orderly connected. Dotted lines A and B in FIG. 1 illustrate nominal interfaces of the gel portion 21, the mixed portion 22, and the sensitive portion 23.

The gel portion 21 is made of a first polymer gel. The first polymer gel is a non-sensitive gel, and cannot be triggered by environmental change.

Preferably, the first polymer gel is polyethyleneglycol (PEG) based hydrogel.

Preferably, the first polymer gel is polymerized by a first gel pre-polymer. The first gel pre-polymer includes polyethylene glycol methacrylate (PEGMA), ethylene glycol dimethacrylate (EGDMA), and initiator such as Irgacure-1173 (I1173, trade name according to Chemical Industries Basel (CIBA) Corporation).

The sensitive portion 23 is made of a second polymer gel. The second polymer gel is a reversible gel, and a change in state can be triggered by environmental factors, such as a temperature, pH, humidity, light, salt concentration, solvent composition, or electric field.

Preferably, the second polymer gel is thermo-sensitive gel.

Preferably, the second polymer gel is poly N-isopropylacrylamide (PNIPAAm) based hydrogel. The PNIPAAm based hydrogel has a lower critical solution temperature (LCST) at about 32 degrees Celsius. The PNIPAAm based hydrogel can swell in a temperature higher than 32 degrees Celsius, and can shrink in a temperature less than 32 degrees Celsius.

Preferably, the second polymer gel is polymerized by a second gel pre-polymer. The second gel pre-polymer includes N-isopropylacrylamide (NIPAAm), EGDMA, and initiator such as I1173. The second polymer gel has an LCST of about 37 degrees Celsius, which is close to human body temperature.

The mixed portion 22 is a mixture of the first polymer gel and the second polymer gel. From a boundary of the mixed portion 22 connected to the gel portion 21 to a boundary of the mixed portion 22 connected to the sensitive portion 23, a content of the first polymer gel is decreased, and a content of the second polymer gel is increased.

Preferably, the boundary of the mixed portion 22 connected to the gel portion 21 has a first polymer gel-content close to 100%, and a second polymer gel-content close to 0%. The boundary of the mixed portion 22 connected to the sensitive portion 23 has a first polymer gel-content close to 0%, and a second polymer gel-content close to 100%.

The base 10 is made of gel, and can be made of hydrogel or silicone hydrogel.

Preferably, the base 10 is made of a third polymer gel. The third polymer gel is a non-sensitive gel, and cannot be triggered by environmental change.

Preferably, a composite of the third polymer gel is same as a composite of the first polymer gel.

Preferably, the third polymer gel is PEG based hydrogel.

Preferably, the third polymer gel is polymerized by a third gel pre-polymer. The third gel pre-polymer includes PEGMA, EGDMA, and initiator such as I1173.

A thickness of the sensitive layer 20 is defined to be X-S, a thickness of the environmentally-sensitive material 1 is defined to be X-E, preferably, X-S is more than half of X-E.

A length of the sensitive portion 23 is defined to be Y-S, a length of the environmentally-sensitive material 1 is defined to be Y-E, preferably, 3/5 Y-E>Y-S>1/3 Y-E.

The sensitive portion can swell or shrink under a change of environmental factor. When the sensitive portion swells, the environmentally-sensitive material 1 can bend by traction of the sensitive portion. A bending curvature of the environmentally-sensitive material 1 can be defined according to X-S and Y-S. When the sensitive portion shrinks, the environmentally-sensitive material 1 will recover to original size and state.

In other exemplary embodiments, a length of the gel portion 21 can be zero, that is, the gel portion 21 can be omitted.

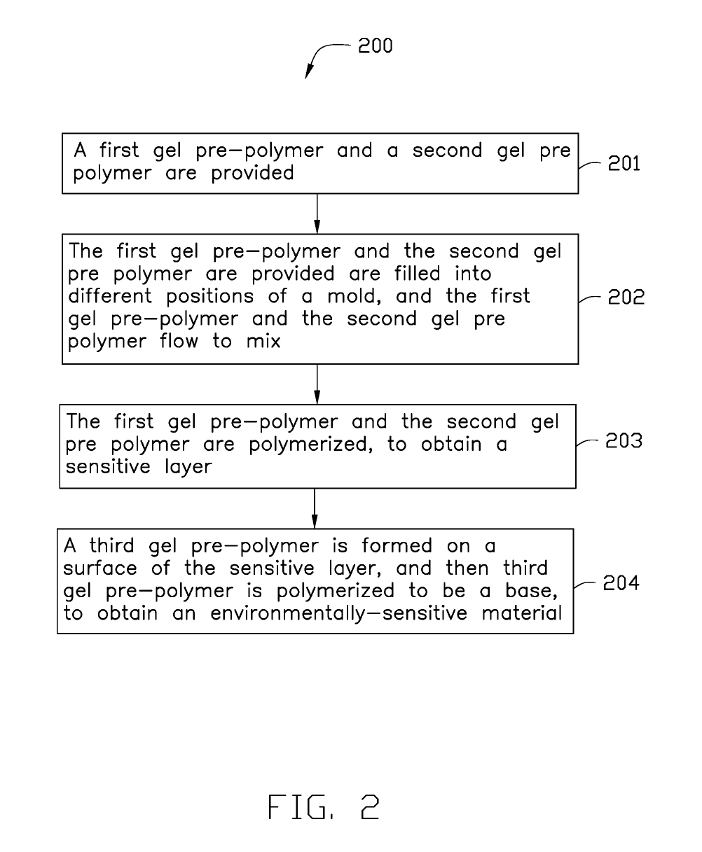

Referring to the FIG. 2, a flowchart shows an example embodiment for a method for preparing an environmentally-sensitive material. An example method 200 is provided by way of example, as there are a variety of ways to carry out the method. The method 200 described below can be carried out using the configurations illustrated in the figure, for example, and various elements of these figures are referenced in explaining example method 200. Each block shown in the figure represents one or more processes, methods, or subroutines, carried out in the exemplary method 200. Additionally, the illustrated order of blocks is by example only and the order of the blocks can change. The exemplary method 200 can begin at block 201.

At block 201, a first gel pre-polymer and a second gel pre polymer are provided.

At block 202, the first gel pre-polymer and the second gel pre polymer are provided are filled into different positions of a mold, and the first gel pre-polymer and the second gel pre polymer flow to mix.

At block 203, the first gel pre-polymer and the second gel pre polymer are polymerized, to obtain a sensitive layer.

At block 204, a third gel pre-polymer is formed on a surface of the sensitive layer, and then third gel pre-polymer is polymerized to be a base, to obtain an environmentally-sensitive material.

The first gel pre-polymer can be polymerized to be a first polymer gel. The first polymer is non-sensitive gel, and cannot be triggered by environmental change.

Preferably, the first gel pre-polymer is polyethyleneglycol (PEG) based hydrogel pre-polymer.

Preferably, the first gel pre-polymer includes polyethylene glycol methacrylate (PEGMA), ethylene glycol dimethacrylate (EGDMA), and initiator such as Irgacure-1173 (I1173, trade name according Chemical Industries Basel (CIBA) Corporation).

The second gel pre-polymer can be polymerized to be a second polymer gel. The second polymer gel is reversible gel, and a change in state can be triggered by environmental factors, such as temperature, pH, humidity, light, salt concentration, solvent composition, or electric field.

Preferably, the second polymer gel is thermo-sensitive gel.

Preferably, the second polymer gel is poly n-isopropylacrylamide (PNIPAAm) based hydrogel. The PNIPAAm based hydrogel has a lower critical solution temperature (LCST) at about 32 degrees Celsius. The PNIPAAm based hydrogel can swell in a temperature higher than 32 degrees Celsius, and can shrink in a temperature less than 32 degrees Celsius.

Preferably, the second gel pre-polymer includes NIPAAm, EGDMA, and initiator such as I1173. The second polymer gel has an LCST of about 37 degrees Celsius, which is close to human body temperature.

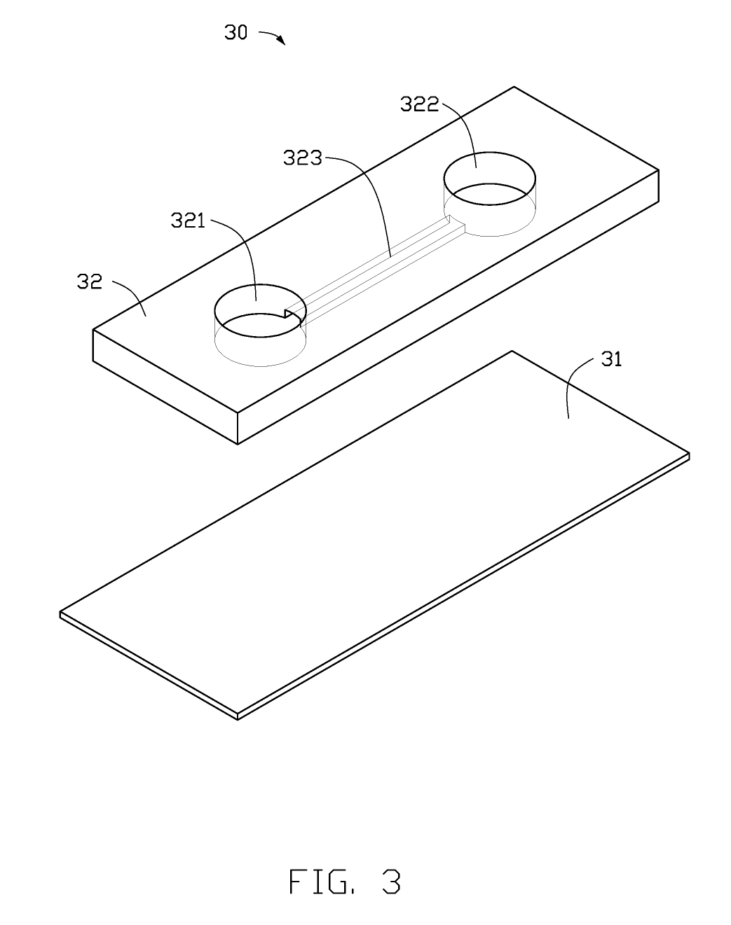

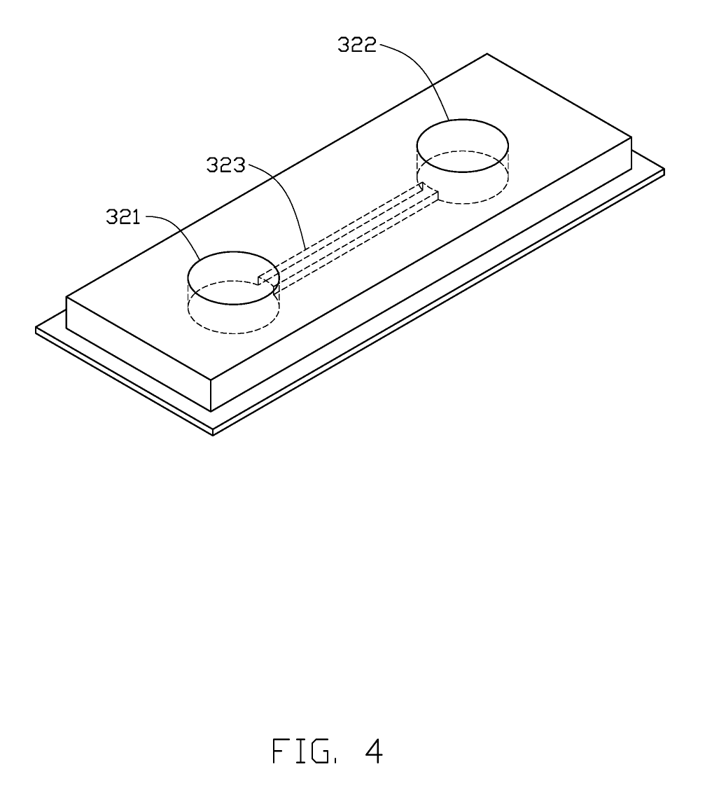

At block 302, as illustrate in FIGS. 3 and 4, a mold 30 is provided. The mold 30 includes a transparent base board 31 and a transparent slot board 32 positioned on a surface of the transparent base board 31. The transparent slot board 32 defines a first injection hole 321, a second injection hole 322 and a sample slot 323. Two ends of the sample slot 323 are separately in air communication with the first injection hole 321 and the second injection hole 322. The first gel pre-polymer is filled into the sample slot 323 through the first injection hole 321, and the second gel pre-polymer is filled into the sample slot 323 through the second injection hole 322, then the first gel pre-polymer and the second gel pre-polymer can be at least partly mixed in the sample slot 323.

Preferably, the mold 30 is made of polydimethylsiloxane (PDMS).

Preferably, the transparent base board 31 is made of glass, and the transparent slot board 32 is made of PDMS.

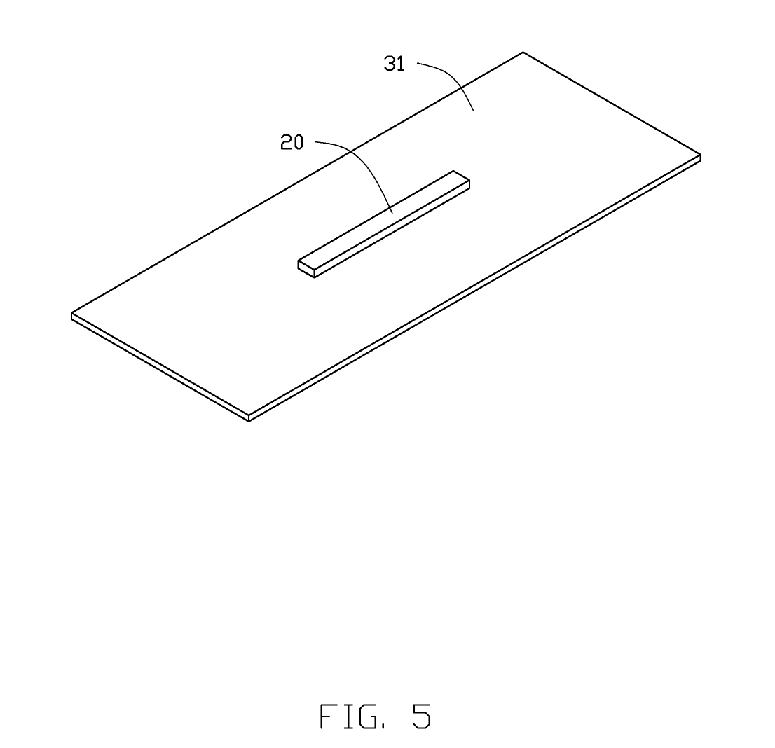

At block 203, as shown in FIG. 5, the first gel pre-polymer and the second gel pre polymer are polymerized, to obtain a sensitive layer 20, and then, the transparent slot board 32 is removed.

Preferably, the first gel pre-polymer and the second gel pre polymer are polymerized under an ultraviolet light.

The first gel pre-polymer is polymerized to be the first polymer gel.

The second gel pre-polymer is polymerized to be the second polymer gel.

As shown in FIG. 1, the sensitive layer 20 includes a gel portion 21, a mixed portion 22, and a sensitive portion 23. The gel portion 21, the mixed portion 22, and the sensitive portion 23 are seamlessly and orderly connected. The gel portion 21 is made of the first polymer gel. The sensitive portion 23 is made of the second polymer gel. The mixed portion 22 is a mixture of the first polymer gel and the second polymer gel. Form a boundary of the mixed portion 22 connected to the gel portion 21 to a boundary of the mixed portion 22 connected to the sensitive portion 23, a content of the first polymer gel is decreased, and a content of the second polymer gel is increased.

Preferably, the boundary of the mixed portion 22 connected to the gel portion 21 has a first polymer gel-content close to 100%, and has a second polymer gel-content close to 0%; the boundary of the mixed portion 22 connected to the sensitive portion 23 has a first polymer gel-content close to 0%, and has a second polymer gel-content close to 100%.

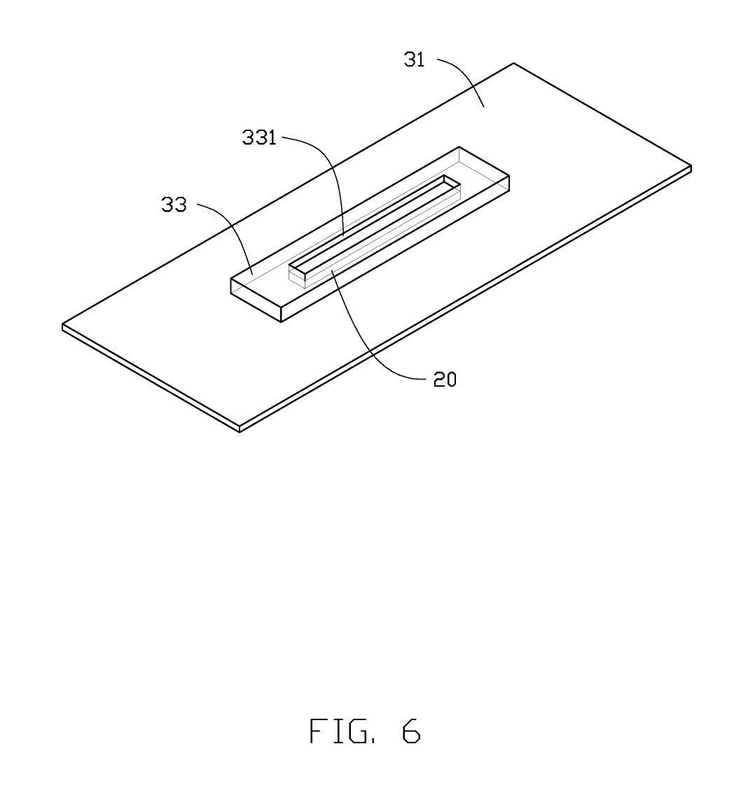

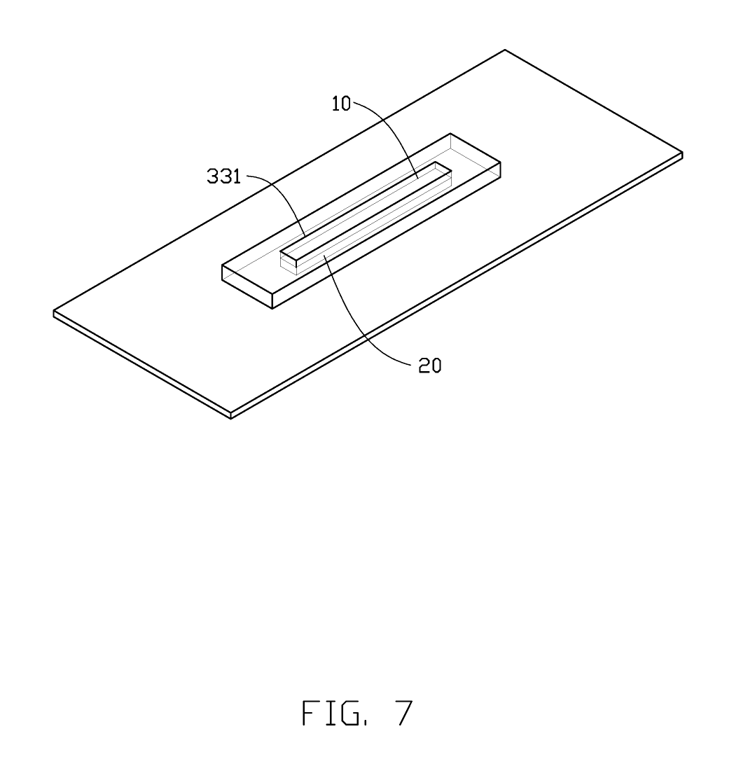

At block 204, as shown in FIGS. 6, 7 and 1, a transparent frame 33 is provided and positioned on the transparent base board 31. The transparent frame 33 defines a receiving groove 331, and the sensitive layer 20 is received in the receiving groove 331. A thickness of the sensitive layer 20 is less than a thickness of the receiving groove 331. Then, a third gel pre-polymer is provided and filled into the receiving groove 331 on a surface of the sensitive layer 20. Then the third gel pre-polymer is polymerized to be a base 10, to obtain an environmentally-sensitive material 1.

The transparent frame 33 is made of transparent materials, such as glass or PDMS.

Preferably, a composite of the third gel pre-polymer is same as a composite of the first gel pre-polymer.

Preferably, the third gel pre-polymer is PEG based hydrogel pre-polymer.

Preferably, the third gel pre-polymer includes PEGMA, EGDMA, and initiator such as I1173.

Preferably, the third gel pre-polymer is polymerized under an ultraviolet light.

Preferably, a thickness of the sensitive layer 20 is defined to be X-S, a thickness of the environmentally-sensitive material 1 is defined to be X-E, preferably, X-S is more than half of X-E.

Preferably, a length of the sensitive portion 23 is defined to be Y-S, a length of the environmentally-sensitive material 1 is defined to be Y-E, preferably, 3/5 Y-E>Y-S>1/3 Y-E.

The exemplary embodiments shown and described above are only examples. Many details are often found in the art such as the other features. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the sections within the principles of the present disclosure, up to and including the full extent established by the broad general meaning of the terms used in the claims. It will therefore be appreciated that the exemplary embodiments described above may be modified within the scope of the claims.

1. An environmentally-sensitive material, comprising:
a sensitive layer, comprising a mixed portion and a sensitive portion, the mixed portion having a first side and a second side opposite to the first side, the entire sensitive portion being seamlessly connected to the second side of the mixed portion, the mixed portion being a mixture of a first polymer gel and a second polymer gel, the sensitive portion being the second polymer gel, the second polymer gel being a reversible gel; and
a base adhered with the sensitive layer.

2. The environmentally-sensitive material of claim 1, wherein the first polymer gel is a non-sensitive gel.

3. The environmentally-sensitive material of claim 2, wherein the first polymer gel is a polyethyleneglycol based hydrogel.

4. The environmentally-sensitive material of claim 3, wherein the second polymer gel is a thermo-sensitive gel.

5. The environmentally-sensitive material of claim 4, wherein the second polymer gel is a poly N-isopropylacrylamide based hydrogel.

6. The environmentally-sensitive material of claim 5, wherein the second polymer gel is polymerized by a gel pre-polymer mixture, comprising a mixture of N-isopropylacrylamide, ethylene glycol dimethacrylate, and an initiator; the second polymer gel has a critical solution temperature of about 37 degrees Celsius.

7. The environmentally-sensitive material of claim 1, wherein from the first side of the mixed portion towards the second side, an amount of the first polymer gel decreases, and an amount of the second polymer gel is increases.

8. The environmentally-sensitive material of claim 7, wherein the first side of the mixed portion a has a first polymer gel with an amount of about 100%, and has a second polymer gel with an amount of about 0%; the second side of the mixed portion has a first polymer gel with an amount of about 0%, and has a second polymer gel-content gel with an amount of about 100%.

9. The environmentally-sensitive material of claim 1, wherein the base is a third polymer gel.

10. The environmentally-sensitive material of claim 9, wherein the third polymer gel is a non-sensitive gel.

11. The environmentally-sensitive material of claim 10, wherein the third polymer gel is the same as the first polymer gel.

12. The environmentally-sensitive material of claim 1, wherein a thickness of the sensitive layer is greater than a thickness of the environmentally-sensitive material.

13. The environmentally-sensitive material of claim 1, wherein a length of the sensitive portion is defined as Y-S, a length of the environmentally-sensitive material is defined as Y-E, and 3/5 Y-E>Y-S>1/3 Y-E.

14. The environmentally-sensitive material of claim 1, wherein the sensitive layer further comprises a gel portion, substantially the entire gel portion is seamlessly connected to the first side of the mixed portion; the gel portion is the first polymer gel.

15. A method for manufacturing an environmentally-sensitive material, comprising:
providing a first gel pre-polymer and a second gel pre polymer;
filling the first gel pre-polymer and the second gel pre polymer into different positions of a mold, the first gel pre-polymer and the second gel pre polymer flowing to mix;
polymerizing the first gel pre-polymer and the second gel pre polymer, to obtain a sensitive layer; and
forming a third gel pre-polymer on a surface of the sensitive layer, and then polymerizing the third gel pre-polymer to be a base, to obtain an environmentally-sensitive material;
wherein the sensitive layer comprises a mixed portion and a sensitive portion seamlessly connected to the mixed portion, the mixed portion is polymerized by a mixture of the first gel pre-polymer and the second gel pre-polymer, the sensitive layer is polymerized by the second gel pre-polymer, the second gel pre-polymer is a reversible gel pre-polymer.

16. The method of claim 15, wherein the mold includes a transparent base board and a transparent slot board positioned on a surface of the transparent base board, the transparent slot board defines a first injection hole, a second injection hole and a sample slot, two ends of the sample slot are separately in air communication with the first injection hole and the second injection hole, the first gel pre-polymer is filled into the sample slot through the first injection hole, and the second gel pre-polymer is filled into the sample slot through the second injection hole, the first gel pre-polymer and the second gel pre-polymer is partly mixed in the sample slot; polymerizing the first gel pre-polymer and the second gel pre polymer under an ultraviolet light.

17. The method of claim 15, wherein the first gel pre-polymer is polymerized to be the first polymer gel, the second gel pre-polymer is polymerized to be the second polymer gel; the gel portion is made of the first polymer gel, the sensitive portion is made of the second polymer gel, the mixed portion is a mixture of the first polymer gel and the second polymer gel; form a boundary of the mixed portion away from the sensitive portion to a boundary of the mixed portion connected to the sensitive portion, a content of the first polymer gel is decreased, and a content of the second polymer gel is increased.

18. The method of claim 15, wherein the first gel pre-polymer is polyethyleneglycol based hydrogel pre-polymer.

19. The method of claim 15, wherein the second gel pre-polymer is N-isopropylacrylamide based hydrogel pre-polymer.

20. The method of claim 19, wherein the second gel pre-polymer comprises N-isopropylacrylamide, ethylene glycol dimethacrylate, and initiator.
